(19) United States
(12) Patent Application Publication
(10) Pub. No.: US 2017/0103677 A1
(43) Pub. Date: Apr. 13, 2017

(54) NUTRITION INTAKE TRACKER

(71) Applicant: MasterCard International Incorporated, Purchase, NY (US)

(72) Inventors: Manash Bhattacharjee, Jersey City, NJ (US); Debashis Ghosh, Charlotte, NC (US); Randy Shuken, Westport, CT (US); Loralee J. Bodo, Hawthorne, NY (US); Jason Alex Feldman, New York, NY (US)

(21) Appl. No.: 14/880,923

(22) Filed: Oct. 12, 2015

(51) Int. Cl. G09B 19/00; G09B 5/02

(52) U.S. Cl. CPC G09B 19/0092; G09B 5/02

(57) ABSTRACT

A nutritional intake tracker computing device (“intake tracker”) is provided. The intake tracker is configured to receive user health data and at least one user health goal from a user computing device, and receive a request for an intake recommendation from the user computing device. The request includes a location identifier of a location of the user computing device. The intake tracker is configured to retrieve available intake options based on the location of the user computing device, wherein each of the available intake options includes corresponding nutritional information. The intake tracker is further configured to process the available intake options, the user health data, the at least one user health goal, and the corresponding nutritional information to generate a recommendation of at least one recommended intake option, and transmit the recommendation to the user computing device for display.

### BACKGROUND

This disclosure relates to consumer health tracking and, more specifically, to a nutrition intake tracker with intake recommendation functionality.

Consumers are increasingly health conscious. For example, consumers want to know how their food intake affects their health and fitness goals, and thus, in many cases, they are particularly interested in the nutritional value of the food they consume. In addition, consumers are using a variety of devices and services to track and improve their activity levels. For example, some consumers use “fitness wearables” that use accelerometers, GPS tracking, and other technology to track the physical activity of the user of the wearable. Such wearables make it simple and convenient for users to track their exercise and other physical activity.

Other consumers may use various “diary”-style services or programs, in which the user manually logs their physical activity by activity type and duration of the activity. Such diary-style services may be time consuming to use, and require the user either to remember all of their activities performed over the course of a day, or to constantly update their activity log throughout the day, which can be tedious and/or inconvenient for many users. Unfortunately, these diary-style services also require the user to manually track their food consumption. The user must enter each and every food they consume in a particular meal or particular day, including the amount of each food consumed, which can be a difficult task to complete accurately. As a result, many users over- or underestimate their food consumption, and many users get tired of the tedious task of entering food into their “food diary,” which leads to the user abandoning the use of the service entirely. This issue may be particularly relevant to users when they eat out at restaurants, where it may be difficult to know, let alone track, the ingredients and amounts of those ingredients that go into a meal. Health-conscious patrons may find it difficult to locate meal options that suit their personal diet goals, and patrons with food allergies or sensitivities may be at risk of consuming an item with an ingredient that they should not or cannot consume.

In addition, some consumers may own or use “smart refrigerators,” which allow the user to scan (e.g., using a barcode scanner) food products into and out of the refrigerator, in order to monitor consumption. However, it may be tedious and time consuming to scan all of a user's groceries into the smart refrigerator. Additionally, the smart refrigerator may not provide nutritional information associated with food put into and/or taken out of the smart refrigerator. The user may still need to enter their eating habits into a food diary or log. In some cases, the smart refrigerator may enable the user to create a virtual shopping list of items that have been fully consumed by the user. However, these known smart refrigerators are very limited and are not able to track brand, store, and interval data for each food item (what kind of products the user buys, where they buy it, and how often they buy it), so the shopping list may not be useful nor as convenient for the user.

### BRIEF DESCRIPTION OF THE DISCLOSURE

In one aspect, a nutritional intake tracker computing device is provided. The nutritional intake tracker computing device includes a processor in communication with a memory. The processor is programmed to receive user health data and at least one user health goal from a user computing device, receive a request for an intake recommendation from the user computing device. The request includes a location identifier of a location of the user computing device. The processor is also programmed to retrieve available intake options based on the location of the user computing device, wherein each of the available intake options includes corresponding nutritional information. The processor is further programmed to process the available intake options, the user health data, the at least one user health goal, and the corresponding nutritional information to generate a recommendation of at least one recommended intake option, and transmit the recommendation to the user computing device for display.

In another aspect, a computer-implemented method for tracking the intake of a user and providing an intake recommendation using a nutritional intake tracker computing device is provided. The method includes receiving user health data and at least one user health goal from a user computing device, and receiving a request for an intake recommendation from the user computing device. The request includes a location identifier of a location of the user computing device. The method also includes retrieving available intake options based on the location of the user computing device, wherein each of the available intake options includes corresponding nutritional information. The method further includes processing the available intake options, the user health data, the at least one user health goal, and the corresponding nutritional information to generate a recommendation of at least one recommended intake option, and transmitting the recommendation to the user computing device for display.

In yet another aspect, at least one non-transitory computer-readable storage media having computer-executable instructions embodied thereon is provided. When executed by at least one processor, the computer-executable instructions cause the processor to receive user health data and at least one user health goal from a user computing device, and receive a request for an intake recommendation from the user computing device. The request includes a location identifier of a location of the user computing device. The computer-executable instructions also cause the processor to retrieve available intake options based on the location of the user computing device, wherein each of the available intake options includes corresponding nutritional information. The computer-executable instructions further cause the processor to process the available intake options, the user health data, the at least one user health goal, and the corresponding nutritional information to generate a recommendation of at least one recommended intake option, and transmit the recommendation to the user computing device for display.

### BRIEF DESCRIPTION OF THE DRAWINGS

FIGS. 1-12 show example embodiments of the methods and systems described herein.

FIG. 1 is a block diagram of a nutritional intake tracking (NIT) system including a nutritional intake tracker computing device (“intake tracker”).

FIG. 2 is a schematic diagram illustrating an example multi-part payment card industry system in communication with the NIT system shown in FIG. 1 for enabling payment-by-card transactions.

FIG. 3 illustrates an example configuration of a client computing device shown in FIG. 1.

FIG. 4 illustrates an example configuration of a server system shown in FIG. 1.

FIG. 5 is a first example screenshot of an NIT application showing an intake recommendation provided by the intake tracker shown in FIG. 1.

FIG. 6 is a second example screenshot of the NIT application, shown in FIG. 5, showing an intake recommendation provided by the intake tracker shown in FIG. 1.

FIG. 7 is an example screenshot of the NIT application, shown in FIG. 5, showing a bill screen.

FIG. 8 is a third example screenshot of the NIT application, shown in FIG. 5, showing an intake recommendation provided by the intake tracker shown in FIG. 1.

FIG. 9 is an example screenshot of the NIT application, shown in FIG. 5, showing a user's pantry.

FIG. 10 is a fourth example screenshot of the NIT application, shown in FIG. 5, showing an intake recommendation provided by the intake tracker shown in FIG. 1.

FIG. 11 is a flowchart of a method for tracking the nutritional intake of a user and providing an intake recommendation using the NIT system shown in FIG. 1.

FIG. 12 is a diagram of components of an example computing device that may be used in the NIT system shown in FIG. 1.

Like numbers in the Figures indicates the same or functionally similar components. Although specific features of various embodiments may be shown in some figures and not in others, this is for convenience only. Any feature of any figure may be referenced and/or claimed in combination with any feature of any other figure.

### DETAILED DESCRIPTION OF THE DISCLOSURE

The Nutritional Intake Tracking (NIT) system described herein is configured to advise a user about their nutritional intake. In particular, the NIT system is configured to track a user's health data and available inventory (i.e., the intake options available to the user at any given time) to make intake recommendations to the user (for example, to help a user maintain their health and/or nutritional goals). The NIT system includes a nutritional intake tracking computing device (“intake tracker”) in communication with (i) a transaction processor that is configured to process payment transactions, and/or (ii) a database that stores data related to the transactions (“transaction data”). The transactions are associated with purchases made by cardholders using payment cards, and are processed over a payment network that includes the transaction processor and/or the database. The intake tracker includes a processor in communication with a memory. The intake tracker is further in communication with at least one database for storing information, such as (i) a user's health data and intake goals, (ii) nutritional information about various ingredients, foods, meals, and menu items, and (iii) transaction data association with food- or other health-related transactions initiated by the user and/or by other cardholders.

The intake tracker is further in communication with one or more user computing devices, and is configured to receive a request for a recommendation, in particular, an intake recommendation (e.g., a recommended menu item, recipe, ingredient, etc.), from one of the user computing devices (e.g., a smart phone, laptop, desktop, tablet, fitness wearable, smart refrigerator, etc.). In the example embodiment, the intake tracker receives tracked user health data in the request. As used herein, “user health data” refers generally to data that may impact a user's daily and overall health, such as, but not limited to, caloric intake, other nutritional intake (e.g., saturated fat, vitamin C, calcium, etc.), water intake, caloric output (e.g., physical activity), allergy information, and/or dietary restrictions (e.g., Kosher, Halal, vegan, low salt). The intake tracker may also receive “health goals” or “intake goals” (used interchangeably herein) from the user computing device. Health goals are set by the user to define the desired parameters of, for example, the user's food or nutritional intake (e.g., a target “net calories” consumed or a maximum saturated fat content).

The intake tracker leverages a user's health data and health goals and the nutritional information of available intake options to make intake recommendations to the user. As used herein, “nutritional information” refers generally to the nutritional content associated with a particular item (e.g., a particular food, recipe, menu item, etc.). Nutritional information may include ingredients as well as information such as caloric content, various vitamins and minerals, and macronutrient levels (e.g., fat, protein, carbohydrates).

A user's health data and health goals may be associated with the user through a user profile. The user profile is accessible to the user through one or more user computing devices, for example, through an application or similar software installed on the user computing device and/or through a web browser. As used herein, “NIT application” refers generally to an application configured to enable communication between the user and the intake tracker (e.g., by displaying to the user the output from the intake tracker) and to provide the user with a mechanism to interact with their user profile. It should be understood that the NIT application may include an application on a user computing device that provides the functionality described herein and/or any websites accessible on a web browser that provide similar functionality. In the example embodiment, the user accesses the NIT application on their user computing device to view or edit their user profile, to transmit requests for intake recommendations to the intake tracker, and to receive recommendations from the intake tracker. In the example embodiment, the NIT application is a cloud-based application, such that information associated with the NIT application (e.g., user profiles, nutritional information, etc.) is stored a cloud environment and/or remotely (e.g., not in one centralized database).

One or more user computing device(s) associated with the user may track the user's health data and/or goals, or may receive input associated therewith. At least some of the data in the user profile (e.g., health goals and/or health data) may be input directly or manually by the user, and at least some of the user profile may be automatically tracked, stored, updated, edited, or accessed by the user computing device(s). For example, for one user: (i) the user may define their health goals by inputting the one or more goals into the NIT application using their smart phone; (ii) the user may track their fitness using a fitness wearable, which automatically updates certain health data for the user, such as an activity level, caloric output, and/or heart rate; (iii) the user may track their weight using a smart scale, which automatically updates health data for the user, such as a weight, Body Mass Index (BMI), and/or body composition; and (iv) the user may track their at-home food consumption using a paired smart refrigerator and/or the NIT application on their smart phone, either or both of which may enable the user to scan barcodes of consumed items and add those items and corresponding nutritional information to their health data (e.g., caloric intake, food log, etc.). In other words, the NIT application is configured to enable access from a plurality of user computing device(s) to a user's profile, to make tracking and monitoring the user's health data and/or progress towards health goals more efficient and less burdensome for the user. It should be understood that the preceding examples are for illustration purposes only and should not be construed to limit the scope of the disclosure in any way.

In the example embodiment, the user may be required to manually set up their user profile using the NIT application, wherein “manually set up” includes filling in a number of fields with information associated with the user. In one embodiment, at least some of the user profile may be imported from another source, such as from a health record from the user, for example, from the user's healthcare or health insurance provider and/or from a user profile associated with another application (e.g., a fitness application or a social media application).

The user profile includes health data for the user as well as, in some embodiments, at least one health goal set by the user. The health data may be logged for certain time intervals (e.g., for the entire day, for a week, for a month, for a year, etc.). The health goal may be defined according to certain time intervals as well. For example, one health goal may include a maximum sodium intake per day, while a second health goal may include a certain number of minutes of exercise per week, and a third health goal may include a certain amount of weight lost over the course of a month or a year. The NIT application may enable the user to include any number of health goals in their user profile. In some embodiments, the NIT application may impose a maximum or minimum limit on the number of health goals a user may input to their user profile. For example, the user may be required to have at least one health goal or may input a maximum of three, five, or ten health goals.

The intake tracker is further in communication with at least one merchant computing device. The merchant computing device may include a POS device at a merchant location (e.g., a brick-and-mortar merchant location) and/or may include a virtual merchant POS (e.g., for a merchant with online purchase functionality). In the example embodiment, each merchant computing device is associated with a merchant, such as a restaurant, grocery store, or other vendor having food- or nutritional-related goods and/or services available for purchase.

The intake tracker is configured to communicate with the one or more merchant computing device(s) to determine available intake options associated with the merchant. For example, if the merchant computing device is associated with a restaurant, the merchant computing device may be a restaurant POS device, and may include thereon available menu options (wherein “menu options” are used interchangeably herein with “intake options”). The intake tracker is configured to access the menu options and any nutritional information associated therewith. If the merchant computing device is associated with a grocery store, the merchant computing device may be a grocery store POS device or an inventory computing device, and may include thereon available items for purchase at the grocery store. The intake tracker is configured to access the items for purchase and any nutritional information associated therewith. In one embodiment, the merchant computing device may include the nutritional information thereon, for direct access by the intake tracker. In another embodiment, the nutritional information for each menu item or grocery item is stored in a remote nutritional database. The merchant computing device may include item identifiers such that the intake advisor may access the nutritional database and retrieve the nutritional information for each item using the item identifier.

In the example embodiment, the intake tracker is configured to access or communicate with the one or more merchant computing devices through a cloud-based Application Programming Interface (API), which functions as a middleware layer and facilitates transmission of transaction data from a merchant computing device to the payment network. The API further enables any number of merchant computing device to communicate with the intake tracker and, accordingly, with the user through the NIT application. Additionally, the API enables the user to access and interact with certain features of the merchant computing device(s) through the NIT application, including making mobile payments directly to a merchant POS device. In one embodiment, the user may only be permitted to use the NIT application to make payments to a merchant POS device when the user is in a specific proximity to the merchant POS device (e.g., the user is in a restaurant and may purchase their meal through the NIT application). In other embodiments, the user may be permitted to initiate transaction with the merchant POS device from any location (e.g., the user is making a payment for delivery from a merchant through the NIT application at a location remote from the merchant's location).

The following example illustrates the functionality of the intake tracker in a restaurant setting. A user having an associated user computing device and user profile with the NIT application enters a restaurant. The user computing device is then communicatively coupled to the restaurant POS device (i.e., the merchant computing device). In one embodiment, the restaurant POS device provides a POS identifier (such as, for example, a 6-digit alphanumeric code) to the user computing device for verification of the merchant POS device. In another embodiment, the user computing device may be connected to an additional device, for example at the user's dining table, which facilitates a hardwired or wireless connection to the restaurant POS device without the need for additional verification.

The intake tracker is configured to receive a location identifier from the user computing device that identifies a location of the user. The location identifier may be, for example GPS coordinates (e.g., latitude and longitude). The intake tracker may then use the GPS coordinates to identify the merchant at that location (e.g., using a lookup table) and locates the user computing device as being at that merchant. The location identifier may alternatively or additionally be associated with a predefined location, for example, a “home location” for the user. This home location may be entered or registered with the intake tracker during, for example, a set-up process. In some embodiments, the intake tracker may prompt the user to enter their location, if the location identifier is inconclusive (e.g., has no merchant associated therewith). The intake tracker may be configured to identify whether the user computing device is in a location with multiple merchants (e.g., a food court in a mall or airport), and may present recommendations from all merchants at that location or may prompt the user to identify the location for which they want a recommendation of an intake option.

Based on the location of the user computing device, the intake tracker is configured to retrieve information from the respective restaurant POS device. More specifically, the intake tracker retrieves the menu options and associated nutritional information from the restaurant POS device (and/or any associated nutritional database(s)). In some embodiments, the intake tracker is configured to retrieve an item identifier for each menu option, such as a SKU code or item name. The intake tracker uses the item identifier to access corresponding nutritional information for the menu options from a nutritional database. It should be understood that the “nutritional database” may include publicly available nutritional information, such as nutritional information available on merchant websites. The user may request an intake recommendation from the intake tracker, for example, by selecting a certain command or navigating to a particular page within the NIT application.

In one embodiment, the intake tracker is configured to make a proactive intake recommendation to the user, wherein an “intake recommendation” includes at least one recommended menu option. The intake tracker leverages the available menu options at the restaurant and the user's health data for the day (or, in some cases, for the week, or for other spans of time) to recommend one or more menu options that align with the user's health goal(s). For example, one of the user's health goals may be a maximum intake of any one macronutrient (e.g., a maximum amount of fat) or a maximum caloric intake. The intake tracker determines how many calories or how much of the macronutrient the user has already consumed, based on their health data for the day. The intake tracker then uses the nutritional information for all of the menu options to determine which menu options are available for the user to consume and still meet their health goal. In one embodiment, the intake tracker is configured to recommend at least one menu option in a tiered fashion, for example, returning “highly recommended” options, “fair” options, and “poor”/“bad” or discouraged options to the NIT application for display to the user as green, yellow, and red menu options, respectively. The user may then view the colored options and make an educated choice about what to order at the restaurant.

“Fair options” may include options that may meet one health goal but not another (e.g., have fewer calories but more sodium than the user wants to consume), or may only slightly exceed a particular goal (e.g., include 100 more calories than the user wants to consume that day). The NIT application may include commands that enable the user to input various instructions about what kinds of options should be shown as “fair” options. “Bad” or discouraged items may include options that do not meet one or more of the user's health goals, or that would violate certain dietary restrictions of the user (e.g., that include an allergen). The user may also have the option to use different health goals to request intake recommendations from the intake tracker. For example, in a “default” mode, the intake tracker may generate an intake recommendation based on a first health goal, and the user may select an option for the intake tracker to generate a new intake recommendation based on a second health goal.

In certain situations, the user may be dining in a restaurant (a “current merchant”) in which none of the available menu options will allow the user to meet one or more of their health goals. For example, the intake tracker may determine that consuming any menu option from the current merchant would cause the user to exceed their maximum sodium intake level for the day. In such situations, the intake tracker is configured to use the location of the user computing device, as determined above, to identify nearby alternate merchants (e.g., nearby alternate restaurants). The intake tracker may retrieve the available menu options from the alternate merchants and determine whether any of the alternate merchants offer menu options that are preferable for the user to consume, relative to the menu options at the current merchant (e.g., would enable the user to meet one or more of their health goals). If the intake tracker identifies such an alternate merchant, the intake tracker is configured to generate a recommendation for display on the NIT application that the user re-locate to the alternate merchant. The recommendation may automatically include an intake recommendation for the alternate merchant, such that user may decide whether they wish to re-locate to the alternate merchant.

In another embodiment, the intake tracker may be configured to generate a reactive intake recommendation. In these embodiments, the intake tracker returns all menu options to the NIT application for the user to view. The user may then select one or more menu options and request an intake recommendation from only the selected menu options. The intake tracker may then make the same determinations described above regarding whether one or more of the selected menu options meet one or more health goals of the user. In some embodiments, the intake tracker may generate an intake recommendation with the selected menu options color-coded as described above. In some cases, all of the selected menu options may be returned to the user as red or “bad” options. Accordingly, in some embodiments, the intake tracker may be configured to rank the selected menu options from “best” to “worst” for the user, according to how well each selected menu option aligns with one or more of the user's health goals.

In some embodiments, the intake tracker is further configured to retrieve any active offers, such as coupons or loyalty rewards, from the restaurant POS device (e.g., during the retrieval of the menu options). The intake tracker may return the active offers to the NIT application for display to the user. The offers may be displayed on a separate user interface from the menu options (e.g., on a “View Offers” page of the NIT application). Additionally or alternatively, the active offers may be displayed on the same user interface as the menu options, for example, beside the menu option(s) to which they apply.

In the example embodiment, the user may select a recommended menu option to order from within the NIT application. The intake tracker may transmit the order to the restaurant POS device through the API. The restaurant POS device may return a bill for the recommended menu option (and any other ordered items) to the intake tracker for display to the user at the NIT application. In one embodiment, the NIT application includes digital wallet functionality, such that the user may pair their user profile in the NIT application to their digital wallet and/or one or more payment cards (e.g., credit card or debit card), and may initiate a transaction from within the NIT application. Alternatively or additionally, the NIT application may be “paired with,” or configured to communicate data to and from, a dedicated digital wallet application. The NIT application and/or the restaurant POS device may transmit the bill details to the digital wallet application, from which the user may initiate the bill-pay transaction using their digital wallet and/or a payment card.

Additionally, when the user initiates the transaction for the purchase of the ordered menu option(s), the intake tracker is configured to add the nutritional information for those ordered menu option(s) to the user's health data for the day. The intake tracker may be further configured to use the transaction data to “confirm” the location of the user computing device, which was previously determined using the location identifier. In one embodiment, the intake tracker adds the ordered menu option(s) to the user's health data based on the items present on the bill before the bill is paid. In another embodiment, the intake tracker receives transaction data associated with the payment of the bill and adds to the user's health data those items identified in the transaction data (as described further herein). In some embodiments, the intake tracker may generate one or more notifications to the user after adding the menu option(s). For example, if the user failed to meet one of their health goals, the intake tracker may generate a notification of the same, along with advice or tips for the user to improve the following day (or other interval of interest). If the user met one of their health goals (e.g., consumed their minimum amount of a certain vitamin or mineral), the intake tracker may generate a notification of the same, along with a congratulatory message.

In an alternative embodiment, the user may choose a menu option that they wish to order and may give their order to a server in a conventional manner. The NIT application may enable the user to select an “Add this item to my day” option, to manually add the item and corresponding nutritional information to their health data for the day. Additionally or alternatively, the server may provide a bill or receipt including a scannable barcode or alphanumeric code that the user may scan or enter into the NIT application in order to automatically add any ordered item(s) to their health data for the day.

Although the preceding example described a user dining in a restaurant and using the NIT application to receive an intake recommendation from the intake tracker, it should be understood that the same, similar, or additional functionality may be available for a user ordering in from a merchant (e.g., ordering food to be delivered). For example, the user may access the NIT application to order one or more menu items from the merchant. The NIT application may have access to a merchant computing device for the merchant (e.g., a merchant POS device), via the intake tracker and the API. Additionally or alternatively, the NIT application may be communicatively coupled to, paired with, or otherwise include a dedicated merchant application configured to communicate directly with the merchant computing device. The user may use the NIT application to request and receive an intake recommendation from the intake tracker, to place an order for recommended menu option(s), and/or to initiate a transaction to pay for the order, as described above.

The NIT application may include additional functionality to fully leverage the capabilities of intake tracker to make healthy recommendations to the user in more situations than ordering from a menu. In one embodiment, the intake tracker is configured to recognize a user's commuting schedule and route to work or school. The NIT application may be configured to independently recognize the route and/or may be paired with another application (e.g., a GPS application) to recognize the route. The intake tracker may identify one or more food merchants (e.g., restaurants or grocery stores) along the route. The intake tracker may further determine one or more menu option(s) from at least one of the identified food merchants that are recommended for the user (e.g., align with one or more of the user's health goals).

In another embodiment, the intake tracker is configured to recognize one or more intake options that are frequently purchased by the user. The intake tracker may be configured to retrieve and return for display on the NIT application at least one active offer (e.g., a coupon) associated with the intake option, a similar or related intake option, and/or an associated merchant. The NIT application may additionally provide a mobile ordering function that is pre-populated with the frequently purchased intake option(s).

In the example embodiment, the intake tracker is further configured to provide intake recommendations to a user in a non-restaurant setting as well, for example, when a user is grocery shopping, or eating or preparing a meal at home. The intake tracker is configured to recommend ingredients and/or recipes that enable a user to meet their health goals.

In one embodiment, the intake tracker is in communication with at least one of (i) a transaction processor that is configured to process payment transactions, and/or (ii) a database that stores data related to the transactions (“transaction data”). As described above, in the example embodiment, the transaction processor and the database are part of a payment processing network that is configured to process payment transactions, such as for credit and debit cards. Transaction data includes such elements as a transaction amount, a merchant identifier, and a description of the purchase made (e.g., a particular food item or product). In some implementations, transaction data may further include additional elements such as a location identifier, which may identify where the transaction was initiated (i.e., a location of the consumer), and/or the location of the merchant. The intake tracker receives transaction data associated with purchases of food-related items, made by the user using their payment card. The intake tracker may associate and/or index the transaction data with the user profile for the user, such that the transaction data for the user is only stored and/or processed in conjunction with that user's profile. The intake tracker stores and/or processes the transaction data to determine which items were purchased, from which merchants the items were purchased, and/or which brands of items were purchased. Accordingly, the intake tracker develops a usage history associated with the user profile such that the intake tracker may generate intelligent recommendations (e.g., shopping lists) for the user that accord with their actual item usage preference (e.g., brands, merchants, items).

In addition, the intake tracker uses the transaction data to identify available intake options for the user when the user is at home, by identifying all of the products purchased by the user and assuming that the purchased products are available to the user for consumption or use. The intake tracker may accordingly populate a “my pantry” user interface of the NIT application showing available intake options, such that the user may view the items available to them, for example, for preparing recipes at home. The intake tracker may additionally generate recipe recommendations to the user based on the user's available intake options (referred to generally herein as a user's “pantry”). The recipes may be retrieved from a database (e.g., a recipe database accessible to all users for the NIT application) and/or may be input (or supplemented) by recipes from the user. For example, the user may scan in, type in, or otherwise input various personal recipes or recipes from other sources into the NIT application, which may be stored in cloud-based storage or in a recipe database. The intake tracker may receive or determine the nutritional information associated with each stored recipe.

The intake tracker is further configured to communicate with a smart refrigerator associated with the user. In one embodiment, the user may “pair” the NIT application with their smart refrigerator using an identification or verification code associated with either or both of the NIT application and the smart refrigerator. Conventional smart refrigerators require the user to individually scan each purchased item into the smart refrigerator, which stores a record of the item and may track how often the user scans in each item (e.g., how often the user scans in a new gallon of milk). The user also “scans out” each item when it is used.

In contrast, in this embodiment, the intake tracker is configured to enhance a paired, conventional smart refrigerator (a “paired smart refrigerator”) by using the received transaction data to automatically input all of the user's purchased food items into the paired smart refrigerator. In other words, the intake tracker may “stock” the user's pantry (i.e., the paired smart refrigerator inventory), which eliminates the need for the user to manually scan in all of their grocery products when they return from the grocery store. In the example embodiment, the intake tracker parses the transaction data from a grocery purchase to identify the products purchased, as well as the brands of the products, the location of the grocery store, and the purchase time and date. Accordingly, the intake tracker supplements the “smarts” of the smart refrigerator. In another embodiment, the paired smart refrigerator may be configured to receive the transaction data directly from the transaction processor, and parse the transaction data to identify the purchased products. The user may access their pantry through the NIT application, as described above, and/or through a user interface of the paired smart refrigerator. Additionally, the intake tracker identifies the nutritional information for each item added to the pantry and associates the nutritional information with each item (e.g., in a memory of the paired smart refrigerator and/or in the cloud-based storage associated with the NIT application). The intake tracker and/or the paired smart refrigerator may additionally associate expiration dates with each item according to average or typical expiration intervals for the items (e.g., two to three weeks for a gallon of milk).

The user may still scan out the items as they are used, and may use the user interface of the paired smart refrigerator or the NIT application to report an amount used for each scanned-out item. The user may scan items using scanner functionality of the paired smart refrigerator and/or scanner functionality included in the NIT application (e.g., for items not stored in the refrigerator but in the pantry). The NIT application automatically adds the nutritional information for each scanned-out item to the user's health data. As the user scans out particular items, the intake tracker may update the pantry for the user (e.g., update amounts of items available and/or remove items that have been completely used or consumed).

The user may use the paired smart refrigerator and/or the NIT application to generate a “smart shopping list.” The user may manually add items to the shopping list. Additionally, the paired smart refrigerator may use the usage history (e.g., a purchase frequency or purchase schedule) and/or a sum of the amount(s) used for each scanned-out item to determine that the user needs to purchase the item again and may add the item to the smart shopping list. The paired smart refrigerator may push the shopping list to the NIT application, such that the user may reference the shopping list on their user computing device while grocery shopping. Moreover, based on the transaction data and the usage history for the user, the intake tracker may enhance the smart shopping list to include preferred merchant(s) and/or brand(s) associated with items on the list, wherein “preferred” may refer generally to those merchants/brands with the highest purchase frequency.

The intake tracker may be further configured to recommend certain recipes to the user that would enable the user to meet their health goal(s). For example, the intake tracker may determine that the user has certain ingredients in their pantry and may recommend a healthy recipe that uses those ingredients and/or may populate the smart shopping list with one or more ingredients that the user must purchase in order to make the recommended recipe. Additionally or alternatively, the intake tracker may recognize that the user makes a particular recipe with a particular frequency, and may automatically populate the smart shopping list with the items necessary to complete that recipe.

While the user is at the grocery store, the smart shopping list may be updated or adjusted by the intake tracker based on item availability at that particular merchant. The intake tracker is configured to access a merchant computing device (e.g., a grocery store POS device or an inventory computing device) associated with the grocery store to determine the item availability. For example, if a particular item is sold out, the intake tracker may suggest a replacement item or may simply indicate the unavailability of the item to the user. In some embodiments, the intake tracker is configured to determine whether the item is available at nearby alternate merchants, and may notify the user with a message in the NIT application where the user may purchase the item. The intake tracker may be further configured to return locations of particular items to the NIT application for display to the user. The intake tracker may be configured to identify a particular aisle or shelf at which the user can find each item, in order to save the user time and effort. Once the user has completed their grocery shopping and completed their checkout, the checkout transaction data is processed by the intake tracker to add the purchased items to the paired smart refrigerator and to the available intake options for the user.

In some embodiments, the NIT application is configured to receive active offers (e.g., coupons, rewards, loyalty programs, etc.) from the grocery store merchant(s) identified in the smart shopping list. The intake tracker may retrieve the active offers and push them to the NIT application, or the user may select an option that allows grocery store merchants to push offers to the NIT application directly, when the merchant is identified in the smart shopping list. In some embodiments, certain offers may be to pushed to the user while the user is grocery shopping, including time-sensitive offers (e.g., a certain discount available only for the next hour), proximity-sensitive offers (e.g., pushing a bread coupon while the user is in the bakery section of the grocery store), inventory-sensitive offers (e.g., the merchant desires to sell certain amount of a particular product), and/or usage history-sensitive offers. The grocery store merchant may not have direct access to a usage history of the user but may instead maintain an inventory of active offers, and the intake tracker may direct to the merchant an indication of which active offers are related to the user's usage history, such that the merchant and/or the intake tracker may push relevant offers to the user. The intake tracker may additionally or alternatively be configured to identify certain items on the smart shopping list that have associated active offers (e.g., by color-coding certain items or by providing an identifier next to certain items that the user may select to view the associated offer).

In some embodiments, the intake tracker is further in communication with a computing device associated with a service provider, which provides a health-related service to the user. For example, the service provider may be a gym or health club, or an insurance provider. The intake tracker may send reports to the service provider that include the user's health data and other data from the user's profile. In other words, the intake tracker updates the service provider on how well or how poorly the user is meeting their health goals, or whether the user is maintaining healthy habits and behavior. The service provider may provide rewards to the user based on the reports. For example, the gym may provide a discount on monthly membership subscription or may provide free or discounted fitness classes. As another example, the insurance provider may provide the user a discount on their health insurance premium or a “cash back” incentive.

In the example implementation, any information stored on the NIT system does not include any personally identifiable information (PII), but rather includes analyzed, anonymized, and/or aggregated data that does not specifically identify a consumer (e.g., a cardholder) that initiated a transaction. In other implementations, where the NIT system may store PII, any stored PII is encrypted and/or otherwise secured. Moreover, in any implementations in which PII may be collected, the consumer from which the PII may be collected is provided an opportunity to agree to or deny collection of such data.

The methods and systems described herein may be implemented using computer programming or engineering techniques including computer software, firmware, hardware, or any combination or subset therefor. At least one of the technical problems addressed by this system includes: (i) inefficient and tedious intake tracking using conventional methods; (ii) healthy eating recommendation systems that do not take into account a user's situation or intake options; and (iii) tedious, complicated, and/or inconvenient product tracking using conventional smart refrigerators.

The technical effect of the systems and methods described herein is achieved by performing at least one of the following steps: (a) receiving user health data and at least one user health goal from a user computing device; (b) receiving a request for an intake recommendation from the user computing device, wherein the request includes a location identifier of a location of the user computing device; (c) retrieving available intake options based on the location of the user computing device, wherein each of the available intake options includes corresponding nutritional information; (d) processing the available intake options, the user health data, the at least one user health goal, and the corresponding nutritional information to generate a recommendation of at least one recommended intake option; and (e) transmitting the recommendation to the user computing device for display.

The resulting technical effect achieved is at least one of: (i) convenient and efficient tracking of a user's nutritional intake; (ii) intake recommendations tailored to a user's specific location, intake options, and health goals; and (iii) leveraging transaction data and pairing a smart refrigerator with an intake tracker to improve efficiency in product tracking by the paired smart refrigerator and enhancing shopping lists output therefrom.

In one embodiment, a computer program is provided, and the program is embodied on a computer-readable medium. In an example embodiment, the NIT system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the NIT system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing purchase patterns in industrial, commercial, and residential applications.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

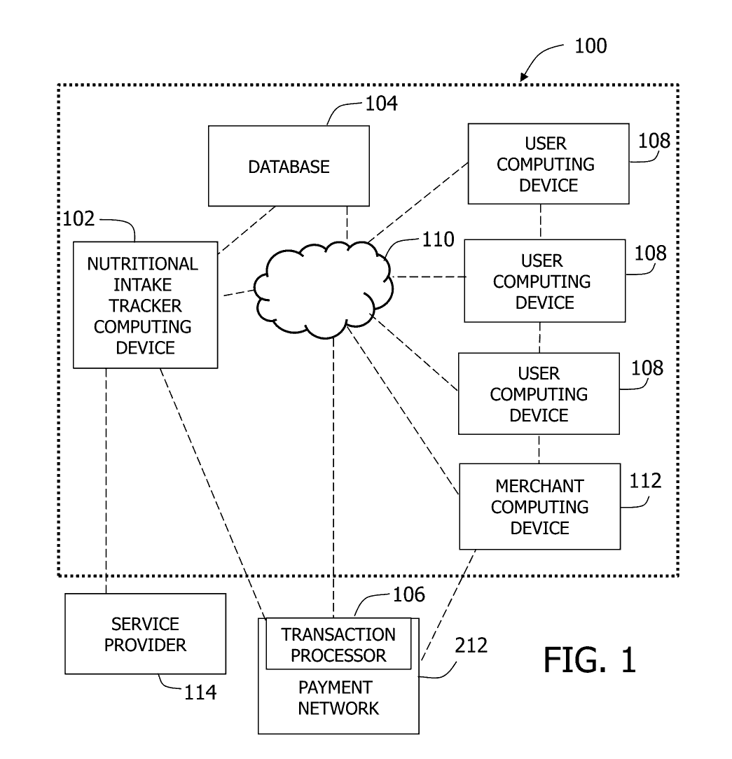

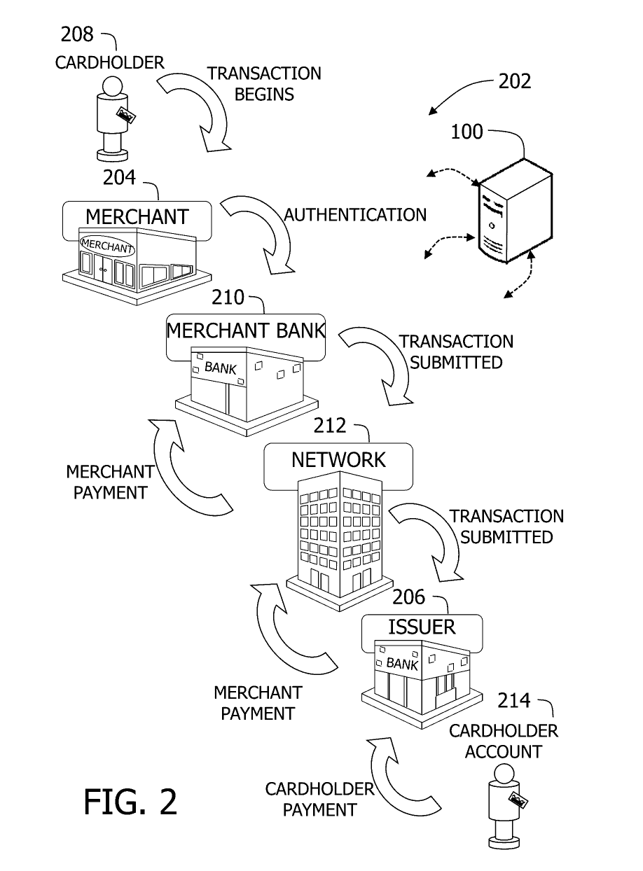

FIG. 1 is a block diagram of a nutritional intake tracking (NIT) system 100 including a nutritional intake tracker computing device (“intake tracker”) 102. Intake tracker 102 includes at least one processor in communication with a memory. Intake tracker 102 is in communication with a database (memory) 104 containing information on a variety of matters, including intake options (also referred to herein as “menu options”), nutritional information for one or more intake options, usage history for one or more users, recipes, stored transaction data for one or more users, and other information described elsewhere herein. In one embodiment, database 104 is stored on intake tracker 102. In any alternative embodiment, database 104 is stored remotely from intake tracker 102 and may be non-centralized. In the example embodiment, NIT system 100 is in communication with a transaction processor 106, which is integral to and/or associated with a payment network 212. Payment network 212 is described more fully herein with respect to FIG. 2

In the example embodiment, NIT system 100 further includes a plurality of client subsystems, also referred to as client systems or user computing devices 108. In one embodiment, user computing devices 108 are computers including a web browser, such that intake tracker 102 is accessible to user computing devices 108 using the Internet. User computing devices 108 are interconnected to the Internet through many interfaces including a network, such as a local area network (LAN) and/or a wide area network (WAN), dial-in connections, cable modems, wireless-connections, and special high-speed ISDN lines. User computing devices 108 may be any device capable of interconnecting to the Internet including a mobile computing device, such as a laptop or desktop computer, a web-based phone (e.g., a “smartphone”), a personal digital assistant (PDA), a tablet or phablet, a fitness wearable device, a smart refrigerator or other web-connectable appliance, a “smart watch” or other wearable device, or other web-connectable equipment. Although three user computing devices 108 are shown in FIG. 1 for clarity, it should be understood that NIT system 100 may include any number of user computing devices 108.

Intake tracker 102 is configured to communicate with a user computing device 108 associated with a user (not shown in FIG. 1). User computing device 108 is configured to execute for display an NIT application. The NIT application may be stored in cloud-based interface 110 (“cloud 110”), which may include cloud storage capability as well as any cloud-based API that facilitates communicates between a merchant computing device 112 and intake tracker 102 and/or between user computing devices 108 and intake tracker 102. The NIT application stores a user profile associated with the user in cloud 110. The user profile includes user health data and user health goals for the user. Additionally, the user profile may be viewed, accessed, and/or updated by user computing devices 108. The user accesses the NIT application to communicate with intake tracker 102, in particular, to request and receive intake recommendations from intake tracker 102.

NIT system 100 further includes merchant computing device 112, which may include a real or virtual point-of-sale (POS) device, an inventory computing device, or any other computing device capable of communicating with transaction processor 106 and/or with intake tracker 102. In the example embodiment, merchant computing device 112 is associated with a merchant (not shown). Intake tracker 102 is configured to access merchant computing device 112 through cloud-based interface 110. Intake tracker 102 is configured to communicate with merchant computing device 112 to access data (e.g., available intake options at the merchant and nutritional information therefor) and/or to access any virtual merchant capabilities of the merchant (e.g., to order delivery of a menu option from the merchant). Additionally or alternatively, at least one of user computing devices 108 may access merchant computing device 112 directly, using the NIT application as an interface, to access the virtual merchant capabilities of the merchant. Although only one merchant computing device 112 is shown in FIG. 1 for clarity, it should be understood that intake tracker 102 may be in communication with any number of merchant computing devices 112.

In the example embodiment, intake tracker 102 receives a request from user computing device 108, the request including a location identifier such that intake tracker 102 may locate user computing device 108. Upon locating user computing device 108, intake tracker determines available intake options for the user at the location. For example, if the user is at a restaurant, intake tracker 102 determines available menu options; if the user is at home, intake tracker 102 determines ingredients and/or food items available to the user based on previous grocery purchases, as described further herein. Intake tracker 102 further determines nutritional information associated with each intake option. Intake tracker 102 may access database 104 to retrieve nutritional information and/or may communicate with merchant computing device 112 through cloud 110 to retrieve nutritional information. Intake tracker 102 then leverages the user's health data and health goals to determine a recommended intake option for the user that enables the user to meet one or more of their health goals, based on the nutritional information for the intake option. Intake tracker 102 generates an intake recommendation including the recommended intake option and returns the recommendation to user computing device 108 for display to the user within the NIT application. Intake tracker 102 receives an indication from user computing device 108 that the user has selected an intake option to consume (e.g., through selection of an “Add” command from the user or through the receipt of transaction data from transaction processor 106 that includes an intake option). Intake tracker 102 adds the nutritional information for the consumed intake option to the user's health data.

In some embodiments, merchant computing device 112 may be configured to push one or more active offers to the user of user computing device 108. In one embodiment, merchant computing device 112 pushes the active offers to intake tracker 102. Intake tracker 102 may then display active offers to the user (using the NIT application), based on the user's location. In another embodiment, intake tracker 102 is configured to retrieve active offers from merchant computing device 112, for example, when intake tracker 102 retrieves available intake options. In yet another embodiment, if the user grants permission to merchant computing device 112, merchant computing device 112 may push active offers directly to user computing device 108 when user computing device 108 is located at the merchant associated with merchant computing device 112.

In one embodiment, at least one user computing device 108 is a paired smart refrigerator. Paired smart refrigerator 108 is paired with (or synced to, or otherwise communicatively coupled with) another user computing device 108 (e.g., a user's smart phone or laptop) to communicate through the NIT application. Paired smart refrigerator 108 accordingly is accessible to and may access intake tracker 102. Paired smart refrigerator 108 includes at least one processor and at least one memory device, such that information may be stored locally on paired smart refrigerator 108. In particular, a list of available intake options at the user's home (i.e., the location of paired smart refrigerator 108) is stored at paired smart refrigerator 108 as the user's “pantry.” The user may view and/or edit the pantry at paired smart refrigerator 108, for example, using a user interface of the paired smart refrigerator 108. The pantry may be further stored on cloud 110 and may be accessible, viewable, and/or editable by intake tracker 102 and/or another user computing device 108. Paired smart refrigerator 108 further includes scanning capability, such that the barcodes of purchased products may be scanned at paired smart refrigerator 108 and identified by the processor therein.

As described further herein, intake tracker 102 is configured to enhance paired smart refrigerator 108 by “stocking the pantry” using received transaction data. In particular, intake tracker 102 receives transaction data from transaction processor 106 associated with a grocery store transaction initiated by a user (i.e., the user associated with paired smart refrigerator 108). Intake tracker 102 parses the received transaction data to identify the products purchase in the grocery store transaction, and adds the identified products to the pantry of paired smart refrigerator 108. Accordingly, the user need not “scan in” all of the purchases products in order to add them to the pantry. In one embodiment, paired smart refrigerator 108 may be configured to receive transaction data directly from transaction processor 106 and parse the transaction data to identify the purchased products to add the products to the pantry. The pantry may be stored locally at paired smart refrigerator 108, stored locally at another user computing device 108 (e.g., at a user's smart phone or laptop computer), and/or stored remotely at database 104.

As the user consumes a product, the user may scan the product using the scanning capability of paired smart refrigerator 108 and/or a scanning capability of another user computing device 108 (e.g., a smart phone). The user may additionally identify an amount of the product used or consumed, and intake tracker 102 will retrieve nutritional information corresponding to the consumed product and update the user's health data for the day with that nutritional information.

In one embodiment, at least one user computing device 108 may be a fitness wearable (e.g., Fitbit® brand products, Jawbone® brand products, Garmin® brand products, or any other fitness wearable; Fitbit is a registered trademark of Fitbit, Inc., San Francisco, Calif.; Jawbone is a registered trademark of AliphCom, San Francisco, Calif.; Garmin is registered trademark of Garmin Ltd., Camana Bay, Cayman Islands). Fitness wearable 108 may refer generally to any wearable or semi-wearable computing device configured to track at least one health or fitness variable for the user (e.g., heart rate, activity, steps, routes, etc.). “Wearable” refers to devices and/or accessories that are attached to, coupled to, or otherwise worn on a user's person. “Semi-wearable” refers to devices and/or accessories that may utilize supplemental accessories or implements to be attached to, coupled to, or otherwise worn on a user's person, for example, a smart phone being held by the user or worn using a supplemental pack or band. Accordingly, fitness wearable 108 includes smart phones and/or other handheld devices that may have one or more fitness, health, or activity-tracking application installed thereon.

The user of fitness wearable 108 may pair fitness wearable 108 (or sync, or otherwise communicatively couple) with their user profile using the NIT application. Accordingly, the NIT application may incorporate the user's activity (or other tracking fitness variable) into the user's health data. For example, if fitness wearable 108 tracks the user's activity for the day and reports that the user has burned 600 calories, a “credit” of 600 calories may be added to the user's health data for the day. For a user with a health goal involving a maximum “net calories” consumed over the course of a day, factoring in their activity enhances the accuracy and appropriateness of the intake recommendations delivered by intake tracker 102.

Intake tracker 102 is further in communication with at least one service provider 114. Service provider 114 represents any entity configured to provide a health-related service to the user. For example, service provider 114 may be a gym or health club, or an insurance provider. Intake tracker 102 may send reports to service provider 114 that include the user's health data and other data from the user's profile. Service provider 114 may provide rewards to the user based on the reports. For example, a gym may provide a discount on monthly membership subscription or may provide free or discounted fitness classes. As another example, an insurance provider may provide the user a discount on their health insurance premium or a “cash back” incentive.

FIG. 2 is a schematic diagram illustrating an example multi-party payment card system 202 in communication with NIT system 100 shown in FIG. 1. NIT system may be in communication with one or more elements of payment card system 202. Payment card system 202 enables payment-by-card transactions for health- and/or food-related purchases. The present disclosure relates to payment card system 202, such as a credit card payment system using the MasterCard® payment card system payment network 212 (also referred to as an “interchange” or “interchange network”). MasterCard® payment card system payment network 212 is a proprietary communications standard promulgated by MasterCard International Incorporated® for the exchange of financial transaction data between financial institutions that are customers of MasterCard International Incorporated®. (MasterCard is a registered trademark of MasterCard International Incorporated located in Purchase, N.Y.).

In payment card system 202, a financial institution such as an issuer 206 issues a payment account card, such as a credit card account or a debit card account, to a cardholder 208, who uses the payment account card to tender payment for a purchase from a merchant 204. To accept payment with the payment account card, merchant 204 must normally establish an account with a financial institution that is part of the financial payment system. This financial institution is usually called the “merchant bank” or the “acquiring bank” or “acquirer bank” or simply “acquirer”. When a cardholder 208 tenders payment for a purchase with a payment account card (also known as a financial transaction card), merchant 204 requests authorization from acquirer 210 for the amount of the purchase. The request may be performed over the telephone, but is usually performed through the use of a point-of-interaction terminal, which may read the cardholder's account information from the magnetic stripe on the payment account card or EMV chip, or may accept the cardholder's account information electronically, and communicates electronically with the transaction processing computers of acquirer 210. Alternatively, acquirer 210 may authorize a third party to perform transaction processing on its behalf. In this case, the point-of-interaction terminal will be configured to communicate with the third party. Such a third party is usually called a “merchant processor” or an “acquiring processor.” In some instances, a merchant (e.g., merchant 204) stores payment card information associated with a cardholder (e.g., cardholder 208) and requests authorization from acquirer 210 using the stored payment card information, rather than reading the cardholder's account information from the payment card itself (i.e., a card-on-file (COF) transaction).

Using payment network 212 (e.g., using a transaction processor such as transaction processor 106, shown in FIG. 1), the computers of acquirer 210 or the merchant processor will communicate with the computers of issuer 206, to determine whether the cardholder's account 214 is in good standing and whether the purchase is covered by the cardholder's available credit line or account balance. Based on these determinations, the request for authorization will be declined or accepted. If the request is accepted, an authorization code is issued to merchant 204.

When a request for authorization is accepted, the available credit line or available balance of cardholder's account 214 is decreased. Normally, a charge is not posted immediately to a cardholder's account 214 because bankcard associations, such as MasterCard International Incorporated®, have promulgated rules that do not allow a merchant to charge, or “capture,” a transaction until goods are shipped or services are delivered. When a merchant ships or delivers the goods or services, merchant 204 captures the transaction by, for example, appropriate data entry procedures on the point-of-interaction terminal. If a cardholder cancels a transaction before it is captured, a “void” is generated. If a cardholder returns goods after the transaction has been captured, a “credit” is generated.

For PIN debit card transactions, when a request for authorization is approved by the issuer, the cardholder's account 214 is decreased. Normally, a charge is posted immediately to cardholder's account 214. The bankcard association then transmits the approval to the acquiring processor for distribution of goods/services, or information or cash in the case of an ATM.

After a transaction is captured, the transaction is cleared and settled between merchant 204, acquirer 210, and issuer 206. Clearing refers to the communication of financial data for reconciliation purposes between the parties. Settlement refers to the transfer of funds between the merchant's account, acquirer 210, and issuer 206 related to the transaction.

Transaction data associated with the transaction is processed by transaction processor 106 and/or is stored in a transaction database (not shown). More specifically, for transactions associated with health- and/or food-related purchases, as described herein, transaction data may include such elements as a transaction amount, a merchant identifier, and a description of the purchase made (e.g., a particular food item or product). In some implementations, transaction data may further include additional elements such as a location identifier, which may identify where the transaction was initiated (i.e., a location of the consumer), and/or the location of the merchant. Transaction data is communicated between transaction processor 106 and intake tracker 102 (shown in FIG. 1).

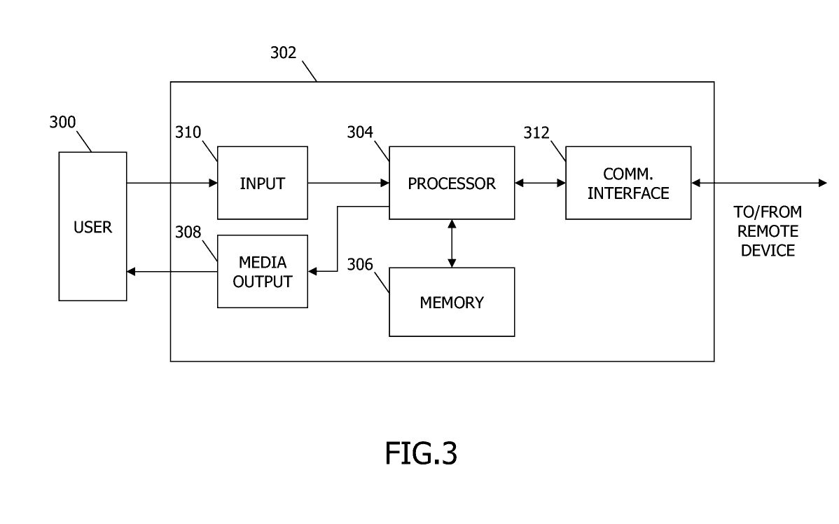

FIG. 3 illustrates an example configuration of a client computing device 302. Client computing device 302 may include, but is not limited to, client systems (“user computing devices”) 108 and/or merchant computing devices 112 (both shown in FIG. 1). Client computing device 302 includes a processor 304 for executing instructions. In some embodiments, executable instructions are stored in a memory area 306. Processor 304 may include one or more processing units (e.g., in a multi-core configuration). Memory area 306 is any device allowing information such as executable instructions and/or other data to be stored and retrieved. Memory area 306 may include one or more computer-readable media.

Client computing device 302 also includes at least one media output component 308 for presenting information to a user 300 (e.g., a cardholder 208). Media output component 308 is any component capable of conveying information to user 300. In some embodiments, media output component 308 includes an output adapter such as a video adapter and/or an audio adapter. An output adapter is operatively coupled to processor 304 and operatively coupleable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 302 includes an input device 310 for receiving input from user 300. Input device 310 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 308 and input device 310.

Client computing device 302 may also include a communication interface 312, which is communicatively coupleable to a remote device such as intake tracker 102 or a web server operated by a merchant (e.g., merchant computing device 112, both shown in FIG. 1). Communication interface 312 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 306 are, for example, computer-readable instructions for providing a user interface to user 300 via media output component 308 and, optionally, receiving and processing input from input device 310. A user interface may include, among other possibilities, a web browser and client application. Web browsers enable users 300 to display and interact with media and other information typically embedded on a web page or a website from a web server associated with a merchant. A client application allows users 300 to interact with a server application associated with, for example, a merchant and/or NIT system 100 (shown in FIG. 1).

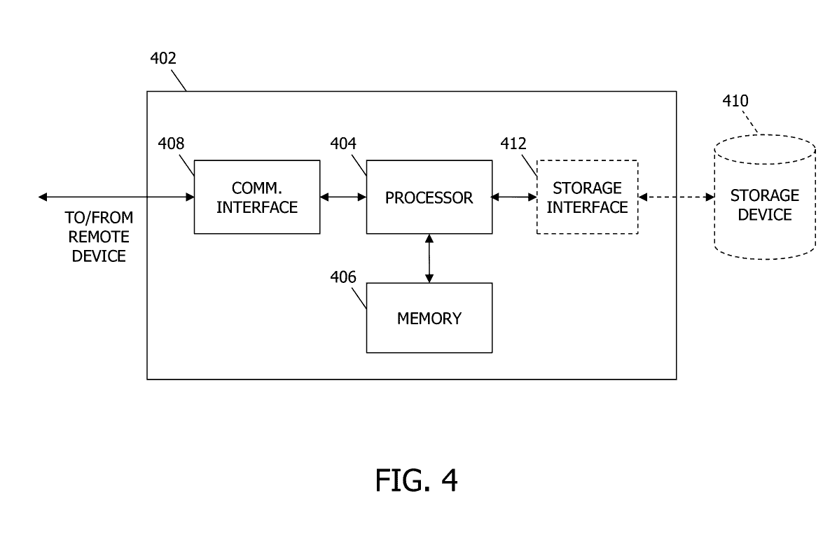

FIG. 4 illustrates an example configuration of a server computing device 402. Server computing device 402 may include, but is not limited to, intake tracker 102, transaction processor 106, merchant computing device 112, and/or service provider 114 (all shown in FIG. 1). Server computing device 402 includes a processor 404 for executing instructions. Instructions may be stored in a memory area 406, for example. Processor 404 may include one or more processing units (e.g., in a multi-core configuration).

Processor 404 is operatively coupled to a communication interface 408 such that server computing device 402 is capable of communicating with a remote device such as client computing device 302 or another server computing device 402. For example, communication interface 408 may receive requests from user computing devices 108 via the Internet, as illustrated in FIG. 1.

Processor 404 may also be operatively coupled to a storage device 410. Storage device 410 is any computer-operated hardware suitable for storing and/or retrieving data. In some embodiments, storage device 410 is integrated in server computing device 402. For example, server computing device 402 may include one or more hard disk drives as storage device 410. In other embodiments, storage device 410 is external to server computing device 402 and may be accessed by a plurality of server computing devices 402. For example, storage device 410 may include multiple storage units such as hard disks or solid state disks in a redundant array of inexpensive disks (RAID) configuration. Storage device 410 may include a storage area network (SAN) and/or a network attached storage (NAS) system.

In some embodiments, processor 404 is operatively coupled to storage device 410 via a storage interface 412. Storage interface 412 is any component capable of providing processor 404 with access to storage device 410. Storage interface 412 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 404 with access to storage device 410.

Memory areas 410 and 306 (shown in FIG. 3) may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

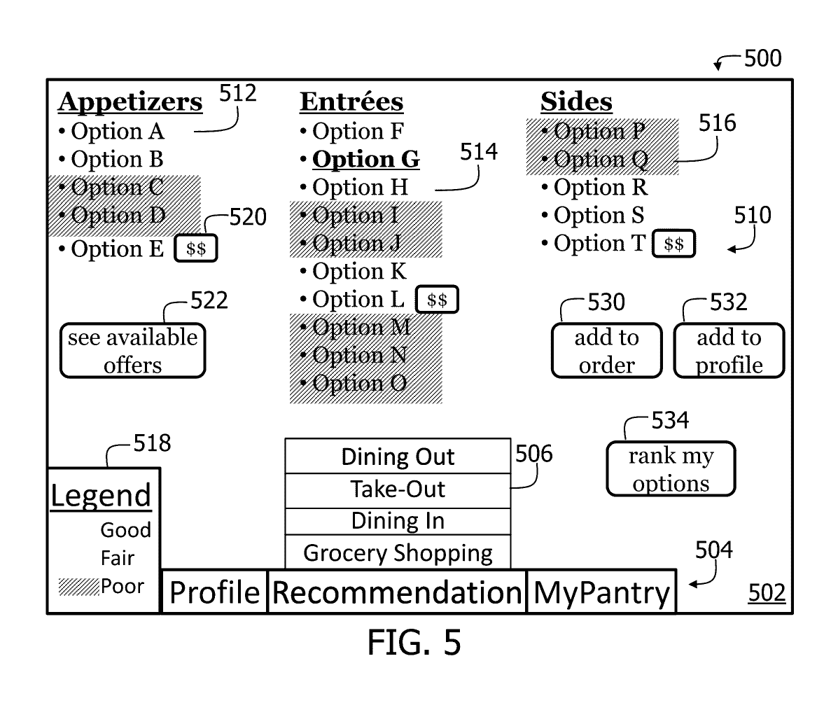

FIG. 5 is a first example screenshot 502 of an NIT application 500 showing an intake recommendation provided by intake tracker 102 (shown in FIG. 1). NIT application 500 is displayed on a user interface of a user computing device 108 (also shown in FIG. 1). In the example embodiment, NIT application 500 provides a plurality of icons 504 for a user (e.g., user 300, shown in FIG. 3) to interact with. Although three icons 504 are illustrated, it should be understood that there may be any number of icons 504 in various alternate embodiments of NIT application 500. In the example embodiment, icons 504 include a “Profile” icon, a “Recommendation” icon, and a “My Pantry” icon.

Selection of the “Profile” icon enables the user to view and interact with their user profile with NIT application 500. For example, the user may view their health data for a particular time period (e.g., one day, one week, two weeks, etc.), edit their health goals, and/or view their progress toward their health goals (e.g., in terms of success/failure, using charts or graphs, etc.). The user is also able to manually edit their health data for the day, for example, by adding food consumed and/or an activity performed.

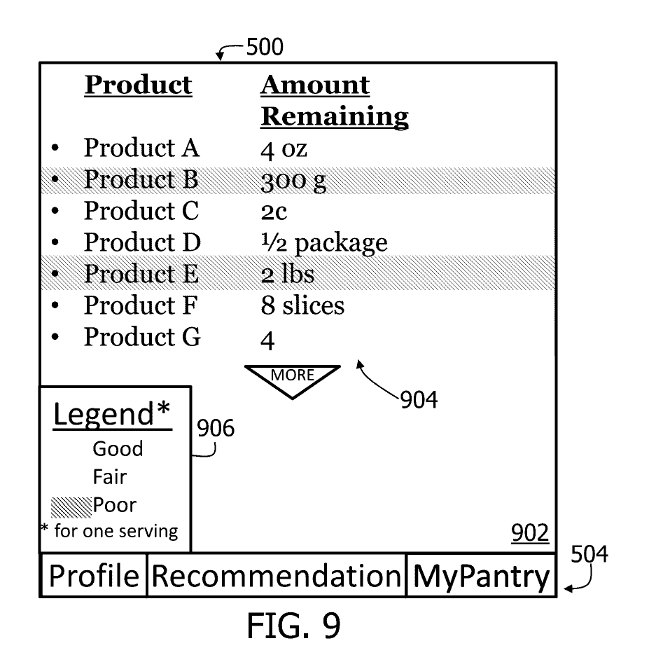

In addition, the user may be able to sync or pair their user profile on NIT application 500 with additional user computing device(s), including, for example, a fitness wearable or a smart refrigerator. The user may select the “Profile” icon or another suitable icon, in an alternate embodiment, and follow instructions provided by NIT application 500 to sync with other user computing device(s). Selection of the “My Pantry” icon will be discussed further herein with respect to FIG. 9.

In the example embodiment, selection of the “Recommendation” icon (illustrated by the shaded “Recommendation” icon 504) causes display of a menu of options 506. The menu of options 506 enables the user to select an appropriate situation (e.g., “Dining Out,” shown shaded to indicate selection, “Take-Out,” “Dining In,” “Grocery Shopping”) for which to receive an intake recommendation. In one embodiment, selecting an option from the menu of options 506 automatically initiates a request for an intake recommendation from intake tracker 102, including the transmission of a location identifier for the user computing device 108 on which the user is accessing NIT application 500. In another embodiment, after selection an option from the menu of options 506, the user may be presented with a dialog (not shown) requesting permission or authorization for the transmission of the location identifier to intake tracker 102.

Screenshot 502 includes a restaurant menu 510 including a plurality of menu options (depicted as “Option A”-“Option T”). The restaurant menu 510 is illustrated with three different shades or colors associated with various menu options. More specifically, a solid shade 512 (which may correspond to a “green” color) highlights Options A, E, G, R, and S. A dotted shade 514 (which may correspond to a “yellow” color) highlights Options B, F, H, K, L, and T. A hatched shade 516 (which may correspond to a “red” color) highlights Options C, D, I, J, M, N, O, P, and Q. As depicted in legend 518, shade 512 indicates “Good” menu options, shade 514 indicates “Fair” menu options, and shade 516 indicates “Poor” menu options. As described elsewhere herein, “Good” menu options enable the user to meet their health goal(s) upon consumption of a corresponding item, based on their pre-existing health data for the day (or other interval relevant to their health goals). “Fair” menu options may enable the user to meet one health goal but not another upon consumption, or may cause the user to approach failure of or fail one or more health goal(s). “Poor” menu options, upon consumption thereof, may cause the user to fail one or all of their health goal(s) or may include one or more ingredients that the user does not consume (e.g., due to various allergies or other dietary restrictions). Intake tracker 102 has recommended, by virtue of the shading/coloring system, at least one of Options A, E, G, R, and S to the user. It should be understood that the shading/coloring system shown and described is for illustrative purposes only and should not be construed to limit the scope of the disclosure.

In the example embodiment, NIT application 500 facilitates the transmission of various active offers (e.g., coupons, sales, discounts, rewards, etc.) from the merchant (e.g., a restaurant) to the user. Icons 520 indicate that there is an offer available that is related to the item thereby. In one embodiment, NIT application 500 may only display icons 520 for active offers from the merchant that are related to “Good” or “Fair” menu options (i.e., may not display icons for active offers related to “Poor” menu options). In addition, NIT application 500 may provide a command 522 to view all active offers (e.g., all active offers available from the merchant, regardless of whether they are related to a recommended menu option).

The user may select a menu option from restaurant menu 510 by, for example, tapping, clicking, or hovering over the menu option they wish to order. In the example embodiment, the user has selected Option G. NIT application 500 may, in some embodiments, provide the user with a command 530 to add selected menu option(s) to their order. Selection of the command 530 sends the order to a merchant computing device (e.g., merchant computing device 112, shown in FIG. 1). In other embodiments, NIT application may additionally or alternatively provide the user with a command 532 to add selected menu option(s) to their profile. In other words, the user may select command 532 to add the nutritional information associated with the selected menu option(s) to their health data for the day. Upon selection of command 532, intake tracker 102 may retrieve nutritional information corresponding to the selected menu option(s) (e.g., from an internal memory device, from database 104 shown in FIG. 1, or from merchant computing device 112) for addition to the user's profile (i.e., update the user's health data with Option G).

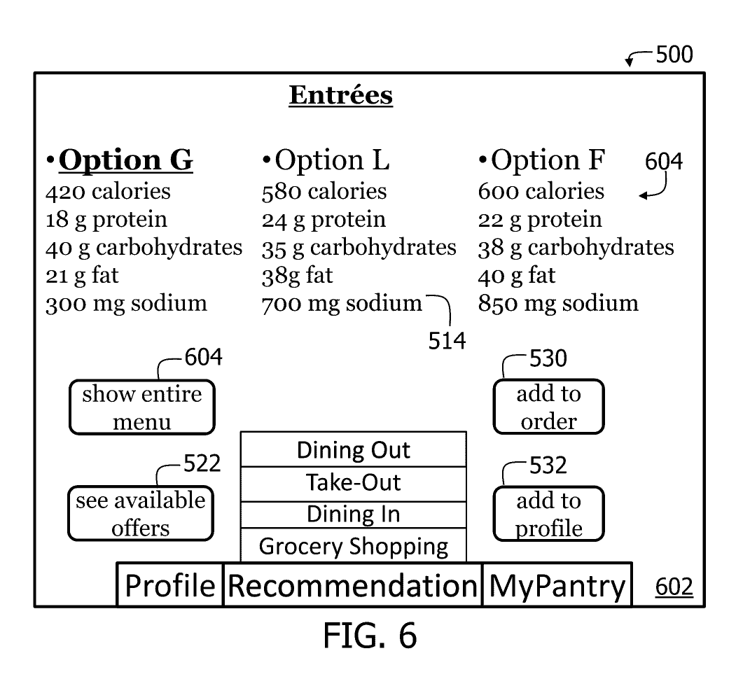

In some embodiments, NIT application 500 may further provide one or more additional commands for the user to filter, sort, or otherwise interact with the recommended menu options. For example, a rank command 534 enables the user to request that intake tracker 102 rank one or more menu options from menu 512. The user may be able to adjust their ranking settings, for example, in their profile, such that the user may impose how many options they want to be ranked (e.g., a top 3, top 5, top 10, only the “Good” options, etc.). In the example embodiment, selection of the rank command 534 causes display of the screen illustrated in FIG. 6.

FIG. 6 is a second example screenshot 602 of NIT application 500 (shown in FIG. 5) showing an intake recommendation provided by intake tracker 102 (shown in FIG. 1). Screenshot 602 may be displayed upon selection of a rank command, as discussed above with respect to FIG. 5. Additionally or alternatively, screenshot 602 may be a default screen for display of intake recommendations from intake tracker 102. In other words, intake tracker 102 may be configured to provide a ranking or sorting of menu options (e.g., recommended menu options and/or selected menu options, selected by the user) by default. Accordingly, NIT application 500 may provide a “show entire menu” command 604, such that the user may view the entire menu (e.g., menu 512, shown in FIG. 5).

In the example embodiment, NIT application 500 facilitates the display of retrieved nutritional information 604 (from intake tracker 102) associated with each of the menu options shown in screenshot 602. Accordingly, the user may be informed more specifically about each of the menu options displayed and/or may be informed about why each menu option was recommended (or given an associated shade or color, as shown in FIG. 5). In the example embodiment, for Options L and F, which were designated as “Fair” options by intake tracker 102, the specific nutritional information that directed such a designation is highlighted with a corresponding shade 514. For example, the level of sodium in Options L and F, as well as the level of fat in Option F, may cause the user to fail one or more health goal(s).

Additionally, screenshot 602 further depicts the “See available offers” command 522, as well as the “add to order” and “add to profile” commands 530, 532 depicted in screenshot 502. Commands 522, 530, 532 have the same functionality as described above.

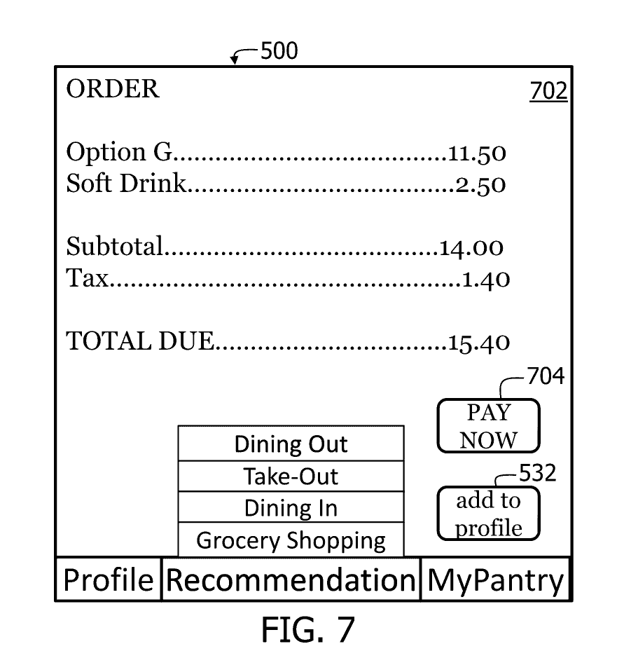

FIG. 7 is an example screenshot 702 of NIT application 500 (shown in FIG. 5) showing a bill screen. Following the examples shown in FIG. 5 and FIG. 6, in which the user selected Option G as their intake option, the bill screen indicates the price for Option G (as well as a soft drink) and an associated tax amount. Notably, the bill screen includes a “pay now” command 704 (as well as the “add to profile” command 532, as described above with respect to FIG. 5). In the example embodiment, selection of the “pay now” command 704 facilitates initiation of a bill-pay transaction from within NIT application 500. For example, NIT application 500 may include digital wallet functionality such that the user may pay for their bill with their digital wallet or a payment card therein. Additionally or alternatively, NIT application 500 may be communicatively coupled to an independent digital wallet application (not shown). In such cases, selection of the “pay now” command 704 may navigate the user to the digital wallet application, where the user may complete their bill-pay transaction.

In either embodiment, selection of the “pay now” command 704 may automatically add the nutritional information from any menu options that are purchased to the user's health data for the day. For example, intake tracker 102 (shown in FIG. 1) may receive transaction data associated with the bill-pay transaction and may parse the transaction data to determine the menu options purchased. Intake tracker 102 may retrieve corresponding nutritional information and may add that nutritional information to the user's health data. Alternatively, intake tracker 102 may receive a notification from NIT application that one or more recommended intake options were ordered and/or paid for. Intake tracker 102 may reference the already-retrieved nutritional information for those ordered recommended intake options and may add that nutritional information to the user's health data (i.e., update the user's health data with Option G).

In other embodiments, in which the NIT application 500 does not provide digital wallet functionality or a link thereto, or in which the user does not wish to use such functionality (e.g., the user wishes to pay with cash), the user may select the “add to profile” command 532, as described above, to add the nutritional information for the ordered menu options to their health data (i.e., update the user's health data with Option G).

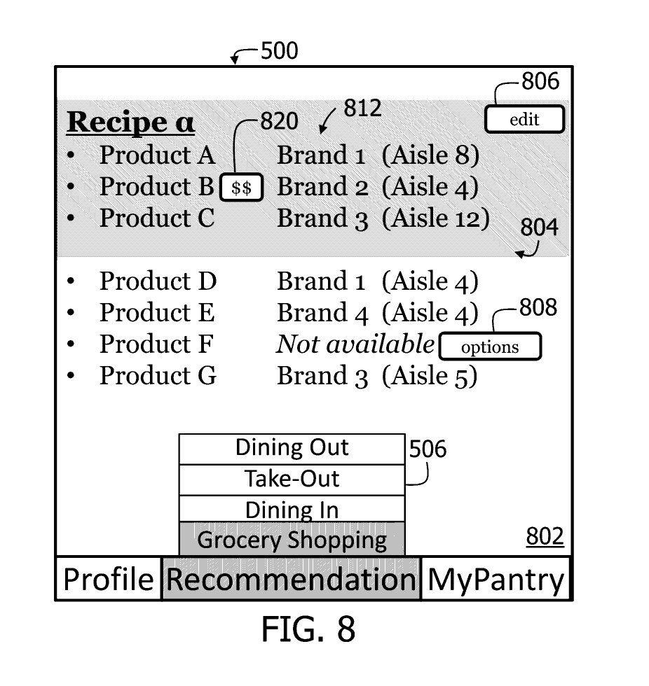

FIG. 8 is a third example screenshot 802 of NIT application 500 (shown in FIG. 5) showing an intake recommendation provided by intake tracker 102 (shown in FIG. 1). In screenshot 802, the user has selected a “grocery shopping” option from the menu of options 506 (as shown in FIG. 5). Accordingly, the user has received an intake recommendation from intake tracker 102 in the form of a smart shopping list 804. In the example embodiment, smart shopping list 804 includes some products for a Recipe a (Products A-C) as well as additional Products D-G. Recipe a and the associated Products A-C are highlighted by shading 812, which may be similar to shading 512 (shown in FIG. 5). Shading 812 indicates that Recipe a (and associated ingredients) are recommended for the user based on the user's health data and health goals.

Smart shopping list 804 is populated by intake tracker 102 and a paired smart refrigerator (not shown in FIG. 8; e.g., one of user computing device 108 shown in FIG. 1). In the example embodiment, the user has paired their NIT application 500 with a smart refrigerator. Accordingly, intake tracker 102 “stocks” the paired smart refrigerator by parsing received transaction data associated with grocery purchases and adding purchased products to a list of available products on the paired smart refrigerator (the user's “pantry”). The user need not “scan in” individual items to the paired smart refrigerator. The pantry may be stored locally on the paired smart refrigerator, stored locally on another user computing device, and/or stored remotely in a database (e.g., database 104, shown in FIG. 1). As the user consumes the products, they may “scan out” those products and identify an amount used. Accordingly, the paired smart refrigerator and/or intake tracker 102 may track the available intake options and determine how much of each product remains. (Intake tracker 102, as described above, also adds nutritional information corresponding to the consumed products to the user's health data.) When the paired smart refrigerator and/or intake tracker 102 determines that the product has been used (e.g., by tracking an amount used and/or by receiving an indication from the user that the product has been fully consumed), the product is added to the smart shopping list 804. In the example embodiment, consumed (or needed) products are grouped in the smart shopping list 804 according to recipe (e.g., Recipe a), with additional products (i.e., those not needed for any particular recipe but that have been consumed by the user) at the end of the list 804. The user may select an edit command 808 to edit the smart shopping list 804 (e.g., to remove a product from the list 804 or to add a product to the list 804).

Intake tracker 102 is configured to parse received transaction data not only for the particular products purchased but also for the merchant from whom the products were purchased and/or the particular brand of product purchased. Accordingly, the smart shopping list 804 further provides a brand corresponding to each product on the list 804 and identifies a merchant (not shown) that the user typically (e.g., most frequently, most recently, on average, etc.) purchases from. The smart shopping list 804 also indicates which of the products on the smart shopping list are unavailable from the merchant. Intake tracker 102 may communicate with one or more merchant computing devices 112 (shown in FIG. 1) to determine an available inventory at the merchant of the products, in order to provide an indication of availability on the smart shopping list 804. For unavailable items, selection of an “options” command 808 causes intake tracker 102 to communicate with merchant computing devices 112 associated with alternate merchants to determine whether the unavailable product is available at one or more alternate merchant(s). Intake tracker 102 may further communicate with one or more merchant computing devices 112 associated with the merchant to determine an approximate location within the merchant at which each product is found (shown in shopping list 804 as an aisle number).

In some embodiments, NIT application 500 is configured to receive active offers (e.g., coupons, discounts, rewards, loyalty programs, etc.) from grocery store merchant(s) that the user frequents. Intake tracker 102 may retrieve the active offers and push them to NIT application 500, or the user may select an option that allows grocery store merchants to push offers to NIT application 500 directly, when the merchant is identified in the smart shopping list. In the example embodiment, NIT application 500 provides an icon 820 to indicate to the user that there is an available active offer associated with the product thereby. The user may select icon 820 to view and/or to redeem the corresponding offer.

FIG. 9 is an example screenshot 902 of NIT application 500 (shown in FIG. 5) showing a user's pantry 904, or available intake options at the user's home location. In the example embodiment, the user has selected a “My Pantry” icons from the plurality of icons 504 (shown in FIG. 5) to navigate to their pantry 904. The pantry 904 lists the available intake options (shown as Products A-G) and their corresponding amount(s) remaining. The amount remaining is determined based on the user's self-reported consumption of each product (e.g., by scanning a product at a paired smart refrigerator or using their user computing device 108, and reporting how much of the product they have used, each time they have used it).

In the example embodiment, the products in the pantry have been analyzed by intake tracker 102 (shown in FIG. 1) and given a particular designation. As shown in legend 906, the designations are “Good,” “Fair,” and “Poor,” as described above. Intake tracker 102 provides the designations for display on NIT application 500 according to retrieved nutritional information associated with each available product. Additionally, the designations are provided according to one serving size of the corresponding product. Accordingly, the user may use intake recommendations from intake tracker 102 to make healthy intake decisions both inside and outside of the home.

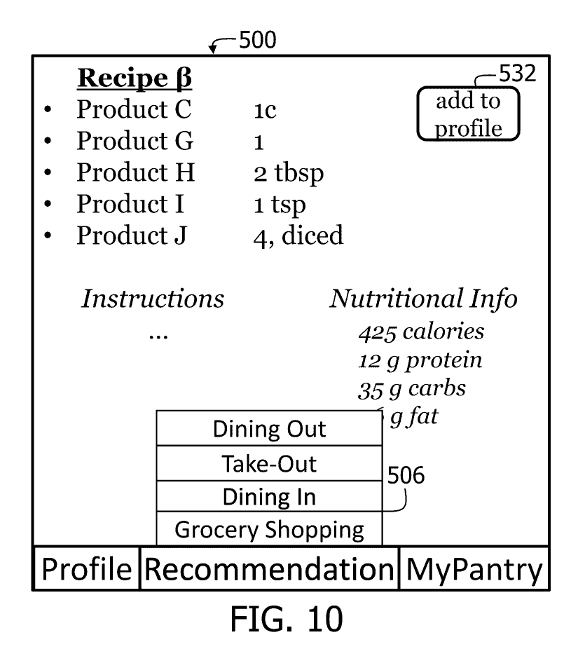

FIG. 10 is a fourth example screenshot 1002 of NIT application 500 (shown in FIG. 5) showing an intake recommendation provided by intake tracker 102 (shown in FIG. 1). In screenshot 1002, the user has selected a “dining in” option from the menu of options 506 (as shown in FIG. 5). Accordingly, intake tracker 102 has leveraged the user's pantry (i.e., their available intake options at home) and a database of available recipes to recommend a recipe that allows the user to meet their health goal(s). In the example embodiment, Recipe β includes Product C and Product G, shown in FIG. 9 as designated “Good” intake options. The intake recommendation further includes the nutritional information associated with Recipe β (for example, for one serving of the completed recipe). NIT application 500 further provides “add to profile” command 532, as described above, that the user may select to automatically add the nutritional information corresponding to one serving of Recipe β to their health data for the day (i.e., update the user's health data with Recipe β).

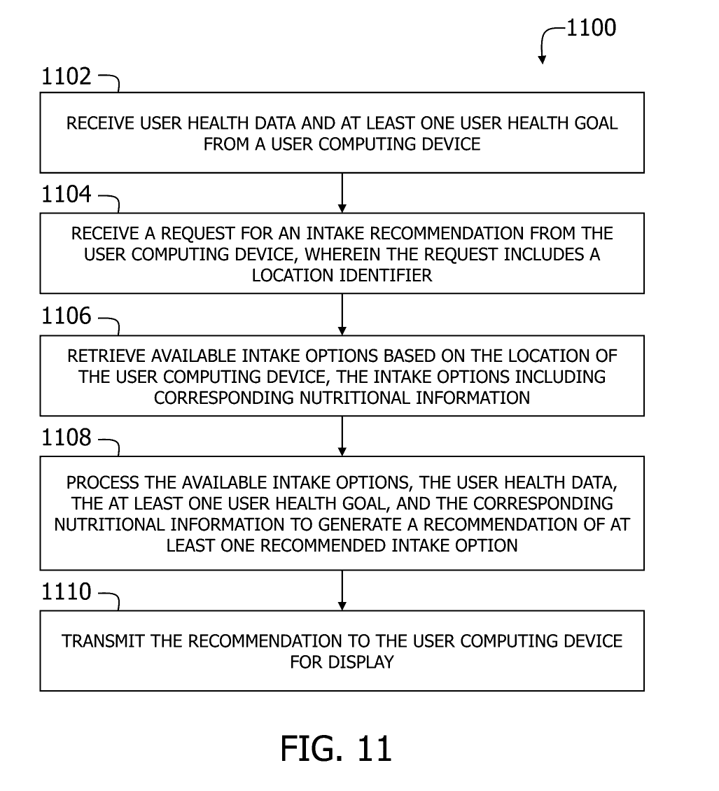

FIG. 11 is a flowchart of a method 1100 for tracking the nutritional intake of a user and providing an intake recommendation using the NIT system 100 shown in FIG. 1. Method 1100 includes receiving 1102 user health data and at least one user health goal from a user computing device (e.g., user computing device 108, shown in FIG. 1). Method 1100 also includes receiving 1104 a request for an intake recommendation from the user computing device. The request includes a location identifier of a location of the user computing device. Method 1100 further includes retrieving 1106 available intake options based on the location of the user computing device. Each of the available intake options includes corresponding nutritional information therefor. Method 1100 also includes processing 1108 the available intake options, the user health data, the at least one user health goal, and the corresponding nutritional information to generate a recommendation of at least one recommended intake option, and transmitting 1110 the recommendation to the user computing device for display. It should be understood that method 1100 may include additional, fewer, or different steps, including those described elsewhere herein.

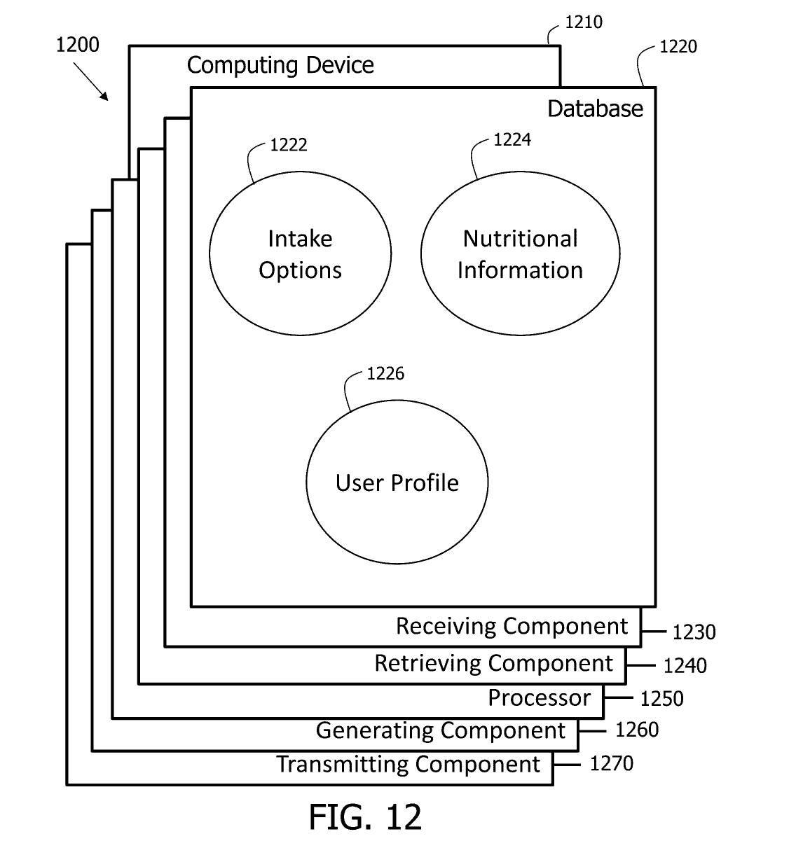

FIG. 12 is a diagram 1200 of components of an example computing device 1210 that may be used in the NIT system 100 shown in FIG. 1. In some embodiments, computing device 1210 is similar to intake tracker 102 (shown in FIG. 1). A database 1220 may be coupled with several separate components within computing device 1210, which perform specific tasks.

In the example embodiment, computing device 1210 includes a receiving component 1230. Receiving component 1230 may be configured to receive user health data and at least one user health goal from a user computing device (e.g., user computing device 108, shown in FIG. 1). The user health data and user health goal(s) may be stored in the database in user profile 1226 of the user associated with the user computing device. Receiving component 1230 may be further configured to receive a request for an intake recommendation from the user computing device. The request includes a location identifier of a location of the user computing device. Computing device 1210 uses the location identifier to locate the user computing device, for example, a merchant location or at home.

Computing device 1210 further includes a retrieving component 1240, which is configured to retrieve available intake options 1222 based on the location of the user computing device. Each of the available intake options 1222 includes corresponding nutritional information 1224 therefor. Retrieving component 1240 may retrieve the available intake options 1222, for example, from a merchant computing device or from a paired smart refrigerator. Computing device 1210 further includes a processor 1250 in communication with a generating component 1260. Processor 1250 processes the available intake options 1222, the user health data, the at least one user health goal, and the corresponding nutritional information 1222 to determine at least one recommended intake option 1222. Generating component 1260 is configured to generate a recommendation of the at least one recommended intake option 1222 from the processor. A transmitting component 1270 of computing device 1210 is configured to transmit the recommendation to the user computing device for display. Computing device 1210 may further include a display component (not shown) for displaying the recommendation to the user.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 205, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

In addition, although various elements of the intake advisor are described herein as including general processing and memory devices, it should be understood that the intake advisor is a specialized computer configured to perform the steps described herein for recommending intake options to a user according to their health data and health goals.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A nutritional intake tracker computing device including a processor in communication with a memory, wherein said processor is programmed to:
receive user health data and at least one user health goal from a user computing device;
receive a request for an intake recommendation from the user computing device, wherein the request includes a location identifier of a location of the user computing device;
retrieve available intake options based on the location of the user computing device, wherein each of the available intake options includes corresponding nutritional information;
process the available intake options, the user health data, the at least one user health goal, and the corresponding nutritional information to generate a recommendation of at least one recommended intake option; and
transmit the recommendation to the user computing device for display.

2. The nutritional intake tracker computing device of claim 1, wherein said processor is further programmed to:
receive transaction data associated with a grocery store transaction from a transaction processor;
parse the received transaction data to identify a plurality of products purchased in the grocery store transaction; and
add the plurality of products to the available intake options at a paired smart refrigerator.

3. The nutritional intake tracker computing device of claim 1, wherein said processor is further programmed to:
identify a merchant at the location of the user computing device; and
retrieve the available intake options from at least one merchant computing device associated with the merchant.

4. The nutritional intake tracker computing device of claim 1, wherein said processor is further programmed to retrieve the available intake options from a paired smart refrigerator paired with the user computing device.

5. The nutritional intake tracker computing device of claim 1, wherein said processor is further programmed to:
identify at least one selected intake option, selected by a user of the user computing device;
retrieve nutritional information associated with the at least one selected intake option; and
automatically update the user health data by adding the nutritional information associated with the at least one selected intake option to the user health data.

6. The nutritional intake tracker computing device of claim 5, wherein said processor is further programmed to receive transaction data associated with a bill-pay transaction including the at least one selected intake option, the transaction data including an identifier of the at least one selected intake option.

7. The nutritional intake tracker computing device of claim 5, wherein said processor is further programmed to receive scan data from at least one of a paired smart refrigerator and the user computing device, the scan data including an identifier of the at least one selected intake option.

8. The nutritional intake tracker computing device of claim 5, wherein said processor is further programmed to transmit a health report associated with the user to a service provider, wherein the health report includes the at least one user health goal and the updated user health data.

9. The nutritional intake tracker computing device of claim 1, wherein the at least one recommended intake option meets the at least one user health goal.

10. A computer-implemented method for tracking the intake of a user and providing an intake recommendation using a nutritional intake tracker computing device including a processor in communication with a memory, said method comprising:
receiving user health data and at least one user health goal from a user computing device;
receiving a request for an intake recommendation from the user computing device, wherein the request includes a location identifier of a location of the user computing device;
retrieving available intake options based on the location of the user computing device, wherein each of the available intake options includes corresponding nutritional information;
processing the available intake options, the user health data, the at least one user health goal, and the corresponding nutritional information to generate a recommendation of at least one recommended intake option; and
transmitting the recommendation to the user computing device for display.

11. The computer-implemented method of claim 10, further comprising:
receiving, from a transaction processor, transaction data associated with a grocery store transaction;
parsing the received transaction data to identify a plurality of products purchased in the grocery store transaction; and
adding the plurality of products to the available intake options at a paired smart refrigerator.

12. The computer-implemented method of claim 10, further comprising:
identifying a merchant at the location of the user computing device; and
retrieving the available intake options from at least one merchant computing device associated with the merchant.

13. The computer-implemented method of claim 10, further comprising:
identifying at least one selected intake option, selected by a user of the user computing device;
retrieving, from the memory, nutritional information associated with the at least one selected intake option; and
automatically updating the user health data by adding the nutritional information associated with the at least one selected intake option to the user health data.

14. The computer-implemented method of claim 13, wherein said identifying at least one selected intake option comprises receiving transaction data associated with a bill-pay transaction including the at least one selected intake option, the transaction data including an identifier of the at least one selected intake option.

15. The computer-implemented method of claim 13, wherein said identifying at least one selected intake option comprises receiving scan data from at least one of a paired smart refrigerator and the user computing device, the scan data including an identifier of the at least one selected intake option.

16. The computer-implemented method of claim 13, further comprising transmitting, to a service provider, a health report associated with the user, wherein the health report includes the at least one user health goal and the updated user health data.

17. The computer-implemented method of claim 10, wherein the at least one recommended intake option meets the at least one user health goal.

18. At least one non-transitory computer-readable storage media having computer-executable instructions embodied thereon, wherein when executed by at least one processor, the computer-executable instructions cause the processor to:
receive user health data and at least one user health goal from a user computing device;
receive a request for an intake recommendation from the user computing device, wherein the request includes a location identifier of a location of the user computing device;
retrieve available intake options based on the location of the user computing device, wherein each of the available intake options includes corresponding nutritional information;
process the available intake options, the user health data, the at least one user health goal, and the corresponding nutritional information to generate a recommendation of at least one recommended intake option; and
transmit the recommendation to the user computing device for display.

19. The computer-readable storage media of claim 18, wherein the computer-executable instructions further cause the processor to:
receive transaction data associated with a grocery store transaction from a transaction processor;
parse the received transaction data to identify a plurality of products purchased in the grocery store transaction; and
add the plurality of products to the available intake options at a paired smart refrigerator.

20. The computer-readable storage media of claim 18, wherein the computer-executable instructions further cause the processor to:
identify a merchant at the location of the user computing device; and
retrieve the available intake options from at least one merchant computing device associated with the merchant.

21. The computer-readable storage media of claim 18, wherein the computer-executable instructions further cause the processor to:
identify at least one selected intake option, selected by a user of the user computing device;
retrieve nutritional information associated with the at least one selected intake option; and
automatically update the user health data by adding the nutritional information associated with the at least one selected intake option to the user health data.

22. The computer-readable storage media of claim 21, wherein the computer-executable instructions further cause the processor to receive at least one of:
transaction data associated with a bill-pay transaction including the at least one selected intake option, the transaction data including an identifier of the at least one selected intake option, and
scan data from at least one of a paired smart refrigerator and the user computing device, the scan data including an identifier of the at least one selected intake option.

23. The computer-readable storage media of claim 21, wherein the computer-executable instructions further cause the processor to transmit a health report associated with the user to a service provider, wherein the health report includes the at least one user health goal and the updated user health data.

24. The computer-readable storage media of claim 18, wherein the at least one recommended intake option meets the at least one user health goal.
